(19) United States
(12) Patent Application Publication
(10) Pub. No.: US 2020/0140040 A1
(43) Pub. Date: May 7, 2020

(54) Boat With An Enhanced Buoyant Body And Foam Filling Method For The Buoyant Body

(71) Applicant: MLRB SDN. BHD, Sarawak (MY)

(72) Inventor: Ting-Wei Chang, New Taipei City (TW)

(21) Appl. No.: 16/182,960

(22) Filed: Nov. 7, 2018

(51) Int. Cl. B63B 5/24; B63B 1/04; B63B 9/06; B29C 44/18; B29C 44/60; B29B 7/82; C08G 18/48; C08G 18/76

(52) U.S. Cl. CPC B63B 5/24; B63B 1/04; B63B 9/06; B29C 44/18; B29K 2105/04; B29B 7/823; C08G 18/48; C08G 18/7657; C08G 18/7671; B29C 44/60

(57) ABSTRACT

The present invention relates to a boat with an enhanced buoyant body and a foam filling method for the buoyant body, wherein a first material of polyether polyol as well as a second material mixed by polymethylene polyphenyl polyisocyanate and methylene bisphenyl isocyanate build up the foam material of the buoyant body, whereby it is achieved, that safety is improved while filling the foam material.

### TECHNICAL FIELD

The present invention relates to a boat with an enhanced buoyant body and foam filling method for the buoyant body; particularly to a buoyant body, consisted of a first cladding as well as a foam material filled in the said first cladding therein, wherein the foam material in the buoyant body is improved; and to an improved foam filling method for a buoyant body.

### BACKGROUND ART

Patent document 1: Taiwan patent publication Nr. M381588.

In the patent document 1, the applicant disclosed an “Anti-overturned onshore lifeboat”, characterized in that a buoyant body is consisted of a cladding as well as foam material filled in the cladding. Even the cladding is damaged accidentally, problems like water seepage within the cladding or impairment of buoyancy are avoided. After years of development, such a boat with a foam filled cladding of a buoyant body can be termed as a foam filled boat.

A conventional foam filled boat is developed based on a rubber boat, Thereby, lot of costs for structural design is saved. Besides, a cladding of the buoyant body is filled with foam material, whereby strength of the buoyant body is enhanced. Hence, it is widely applied to lifeboat, transport boat, fishing boat and so on.

The patent document 1 disclosed only foam material made of polyurethane foam or other similar styrofoam material, like EVA. However, there are differences between different styrofoam materials, e.g. substrate and foaming agent are different; the reaction time after mixing substrate and foaming agent is different; melting temperature is different; foaming temperature is different. All the above conditions can affect the staff, surroundings, e.g. if the reaction time after mixing substrate and foaming is too short, it is difficult to mix evenly before processing in the foaming status. Besides, for some conventional foam materials is the foaming temperature by ca. 120 grad, wherein the cladding can only made of material, which can hold up the temperature of said foaming temperature. Therefore, material choice for the cladding is restricted, e.g. polyvinyl chloride (PVC) is not possible.

In view of these disadvantages the inventor tried the continuous testing and improvement and developed the present invention.

### SUMMARY OF THE INVENTION

The main object of the present invention is to provide a boat with an enhanced buoyant body, wherein safety is improved while filling foam material. For achieving above object, the present invention provides a boat with an enhanced buoyant body, comprising: a buoyant body, which is a U-shaped tube, consisted of a first cladding and a first foam material filled in the said first cladding; a bottom plate, set on the bottom of the buoyant body; and a tail plate, set at the rear of the buoyant body and the bottom plate, wherein the first foam material of the buoyant body is made of a first material and a second material; wherein the first material is made of polyether polyol, while the second material is mixed by polymethylene polyphenyl polyisocyanate and Methylene bisphenyl isocyanate.

Preferably, the first foam material of the buoyant body comprises: 100 weight portions of first material and 80-120 weight portions of second material, so that destined reaction time, foaming temperature, are under control of the optimal situation for filling the first cladding of the buoyant body.

Preferably, outside around the buoyant body there is a cylindric anti-collision tube, which builds up a protective structure of the buoyant body.

Preferably, the said anti-collision tube is consisted of a second cladding and a second foam material filled in the said second cladding, wherein the second foam material of the anti-collision tube is mixed by the first material and the second material. Thereby safety is improved while filling the second foam material in the anti-collision tube.

Preferably, the second foam material of the anti-collision tube comprises: 100 weight portions of the first material and 80-120 weight portions of the second material.

The other object of the present invention is to provide a foaming method with improved safety, while filling foam material in the buoyant body.

For achieving above object, the present invention comprises these steps: S11: control step, to control the temperature of the first material in a destined range, wherein the first material is consisted of polyether polyol; S12: mixing step, to mix the first material and the second material into mixture; wherein the second material is mixed by polymethylene polyphenyl polyisocyanate and Methylene bisphenyl isocyanate; S13: perfusion step, to mold the mixture in the first cladding of a buoyant body, for foam filling in the buoyant body.

Preferably, the destined temperature is higher than or equal to the freezing point of the first material, and the destined temperature is lower or equal to the boiling point of the first material, whereby the first material and the second material are evenly mixed.

Preferably, the mixture of the first material and the second material comprises 100 weight portions of first material and 80-120 weight portions of second material, whereby destined reaction time and temperature by foaming status of the mixture are under control of the optimal situation for filling in the first cladding of the buoyant body.

Owing to the material features of polyether polyol of the first material in the present invention, if the temperature of the polyether polyol closer to the freezing point is, is the destined reaction time longer after mixing the first material and the second material before processing in foaming status. Therefore, it is possible to control the destined reaction time through control of the temperature of the polyether polyol. Thereby, the staff can mix the first material and the second material evenly, disadvantages, like incomplete foaming due to uneven mixing, are reduced. Besides, since destined reaction time of the mixture is under control, it is not necessary to mold the mixture in the first cladding urgently, hence safety of foaming process is improved.

Other aspects and advantages of the present invention will become apparent from the following detailed description, taken in conjunction with the accompanying drawing, illustrating by way of example the principles of the present invention.

### BRIEF DESCRIPTION OF THE DRAWINGS

FIG. 1 is a three-dimensional view of a boat with an enhanced buoyant body of the present invention.

FIG. 2 shows the structure of a buoyant body of the present invention.

FIG. 3 is the flow chart of the foam filling method for the buoyant body of the present invention.

### DETAILED DESCRIPTION OF PREFERRED EMBODIMENTS

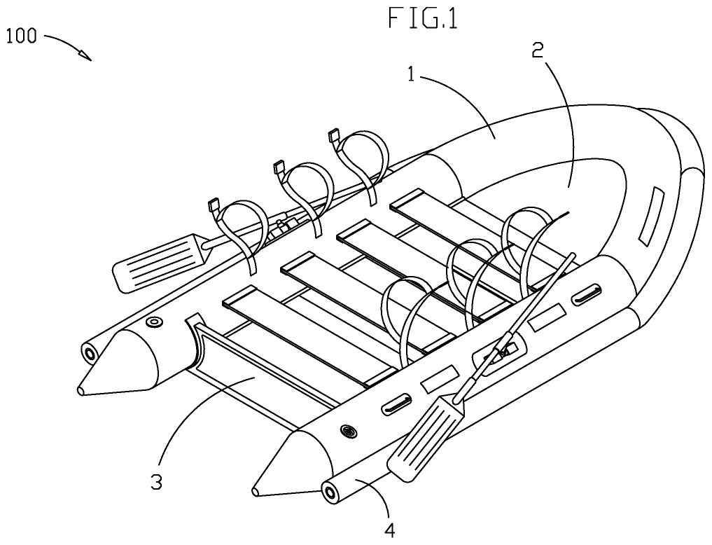

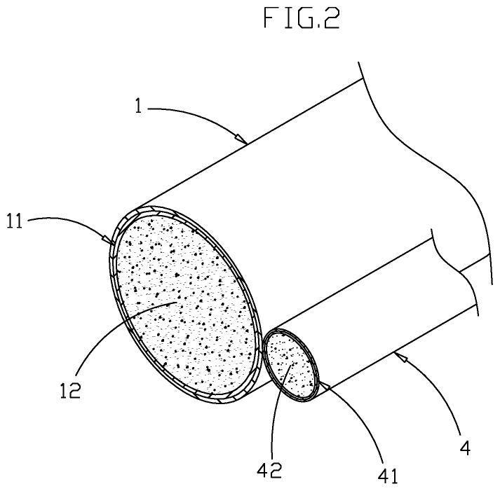

As shown in FIG. 1-2, a boat 100 with an improved buoyant body of the present invention comprises: 1 buoyant body 1, which is a U-shaped tube, consisted of a first cladding 11 and foam material 12 filled in the said first cladding 11 therein; a bottom plate 2, set on the bottom of the buoyant body 1; and a tail plate 3, set at the rear of the buoyant body 1 and the bottom plate 2, wherein the foam material 12 of the buoyant body 1 is mixed by a first material and a second material; wherein the first material is made of polyether polyol, while the second material is mixed by polymethylene polyphenyl polyisocyanate and Methylene bisphenyl isocyanate. Thereby it is achieved that safety by foaming process is improved.

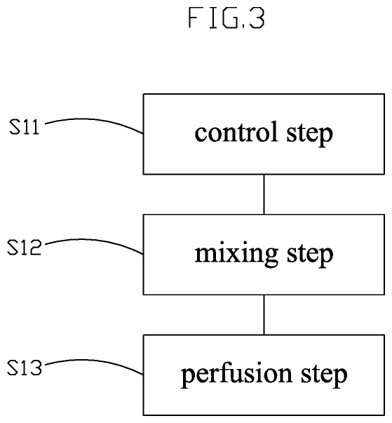

As shown in FIG. 3, the present invention disclosed furthermore a foam filling method of a buoyant body, comprising the following steps: S11: control step, to control the temperature of the first material in a destined range; S12: mixing step, to mix the first material and the second material in mixture; S13: step, perfusion step, to mold the mixture in the first cladding of a buoyant body for foam filling in the buoyant body.

The buoyant body 1, the bottom plate 2 and the tail plate 3 are building up a strong buoyant body, to carry people or wares.

The foam material 12 of the buoyant body 1 is a foamed mixture of the first material and the second material. The first material and the second material of the foam material 12 are made of the polyether polyol (PU-G8912) as well as diphenylmethane diisocyanate (MILLIONATE MR-100) sold by the LIE PO TECHNOLOGY CO., LTD, wherein both are liquid at room temperature. The first material is consisted of polyether polyol. The second material is mixed by polymethylene polyphenyl polyisocyanate and methylene bisphenyl isocyanate, particularly by polymethylene polyphenyl polyisocyanate of lower than 99% concentration and methylene bisphenyl isocyanate of 44% concentration.

Mixture of the first material and the second material is liquid (known as mixture below). After a destined reaction time the mixture is processed into foaming status. While foam-filling process, e.g. the destined reaction time of the mixture and foaming temperature are related to safety of the staff. In the present invention through adding 100 weight portions of the first material to 80-120 weight portions of the second material, with the mentioned foam filling method, thereby, destined reaction time of the mixture and foaming temperature are under control of the optimal station for filling the first cladding of the buoyant body

S11: The control step is to control the temperature of the first material in a destined range. The destined temperature range is any temperature between the freezing point and the boiling point of the first material, that is, the destined temperature is higher than or equal to the freezing point of the first material, and lower than or equal to the boiling point of the first material. Thereby, the first material and the second material are conveniently evenly mixed thereafter.

S12: Mixing step is to mix the first material and the second material into a mixture.

As mentioned, the destined reaction time of the mixture is related to safety of the staff Since the length of the destined reaction time can affect the working time of the staff, in case the destined reaction time is too short, mistakes can be created due to time pressure of the staff. Owing to material features of the polyether polyol of the first material, when temperature of the polyether polyol is closer to the freezing point, the destined reaction time is longer. after mixing the first material and the second material before processing in foaming status. Therefore, it is possible to control the destined reaction time through control of the temperature of the first material, thereby the staff can mix the first material and the second material evenly without urgency. Hence disadvantages like incomplete foaming due to uneven mixing are reduced. Besides, since the destined reaction time of the mixture is under control, it is not necessary to mold the mixture in the first cladding urgently, hence safety of the total foaming process is improved.

S13: perfusion step is to mold the mixture in the first cladding of a buoyant body for foam filling in the buoyant body. By molding the mixture in the first cladding of the buoyant body, it is available to mold the mixture through high pressure perfusion, whereby the first cladding of the buoyant body is on filling after the mixture turning into foaming status.

Outside around the mentioned buoyant body 1 there is a cylindric anti-collision tube 4, whereby not only an anti-collision protective structure is built up, but also stability of the buoyant body is improved. At the same time, it can also provide steps for people in water, while climbing the buoyant body.

The anti-collision tube 4 is consisted of a second cladding 41 and foam material 42 filled within the second cladding 41. The foam material 42 of the anti-collision tube 4 is the same as the foam material 12 of the buoyant body 1, mixed by the first material and the second material. The foam material of the anti-collision tube comprises: 100 weight portions of the first material and 80-120 weight portions of the second material, thereby safety while foam filling in the anti-collision tube 4 is improved.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A boat with an enhanced buoyant body, comprises:
a buoyant body, which is a U-shaped tube, consisted of a first cladding and a first foam material, filled in the first cladding;
a bottom plate, set on the bottom of the buoyant body; and
a tail plate, set at the rear of the buoyant body and the bottom plate;
characterized in that:
the first foam material of the buoyant body is mixing of a first material and a second material; wherein the first material is consisted of polyether polyol, wherein the second material is mixed by polymethylene polyphenyl polyisocyanate and methylene bisphenyl isocyanate.

2. The boat with an enhanced buoyant body as claim 1, characterized in that:
the first foam material of the buoyant body comprises: 100 weight portions of a first material and 80-120 weight portions of a second material.

3. The boat with an enhanced buoyant body as claim 1, characterized in that:
outside around the buoyant body there is a cylindric anti-collision tube.

4. The boat with an enhanced buoyant body as claim 3, characterized in that:
the anti-collision tube is consisted of a second cladding and a second foam material filled within the second cladding; wherein the second foam material of the anti-collision tube is mixed by the first material and the second material.

5. The boat with an enhanced buoyant body as claim 4, characterized in that:
the second foam material of the anti-collision tube comprises: 100 weight portions of the first material and 80-120 weight portions of the second material.

6. A foam filling method of a buoyant body, comprises the following steps:
S11: control step, to control the temperature of the first material in a destined range, wherein the first material is consisted of polyether polyol;
S12: mixing step, to mix the first material and the second material into mixture; wherein the second material is mixed by polymethylene polyphenyl polyisocyanate and Methylene bisphenyl isocyanate;
S13: step, perfusion step, to mold the mixture in the first cladding of a buoyant body for foam filling in the buoyant body.

7. The foam filling method of a buoyant body as claim 6, characterized in that:
the destined temperature is higher than or equal to the freezing point of the first material, and lower than or equal to the boiling point of the first material.

8. The foam filling method of a buoyant body as claim 6, characterized in that:
the mixture mixed by first material and the second material comprises 100 weight portions of the first material and 80-120 weight portions of the second material.
